(19) United States
(12) Patent Application Publication
(10) Pub. No.: US 2026/0089490 A1
(43) Pub. Date: Mar. 26, 2026

(54) COLLECTING QUALITY OF EXPERIENCE (QoE) MEASUREMENTS DURING INTRA-SYSTEM MOBILITY PROCEDURES

(71) Applicant: Lenovo (Singapore) Pte. Ltd., Singapore (SG)

(72) Inventor: Hyung-Nam CHOI, Ottobrunn (DE)

(21) Appl. No.: 19/111,131

(22) PCT Filed: Sep. 29, 2023
(86) PCT No.: PCT/IB2023/059803

§ 371 Date: Mar. 12, 2025

Related U.S. Application Data
(60) Provisional application No. 63/377,952, filed on Sep. 30, 2022.

(51) Int. Cl. H04W 8/24; H04W 28/24; H04W 76/27

(52) U.S. Cl. CPC H04W 8/24; H04W 28/24; H04W 76/27

(57) ABSTRACT

Various aspects of the present disclosure relate to collecting QoE measurements during mobility procedures, such as during intra-system, inter-RAT mobility procedures. For example, a core network can enhance messaging procedures between networks and UEs, expand the capabilities of a UE to perform QoE measurement collection in an LTE network (or during a related handover procedure), and/or extend RRC messaging in LTE and NR networks for handling QoE reports after handovers are completed.

### CROSS REFERENCE TO RELATED APPLICATIONS

This application claims priority to U.S. Provisional Patent Application No. 63/377,952, filed on Sep. 30, 2022, entitled COLLECTING QUALITY OF EXPERIENCE (QoE) MEASUREMENTS DURING INTRA-SYSTEM MOBILITY PROCEDURES, which is incorporated by reference in its entirety.

### TECHNICAL FIELD

The present disclosure relates to wireless communications, and more specifically to collecting quality of experience (QoE) measurements during mobility procedures.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Various radio access technologies (RATs) support QoE (Quality of Experience) Measurement Collection (QMC) for streaming and MTSI (multimedia telephony services for IMS) services. QMC enables operators to collect and utilize collected QoE measurements to better understand the user experience on their networks and optimize or enhance their E-UTRAN (Evolved Universal Terrestrial Radio Access Network) network for the measured services.

### SUMMARY

The present disclosure relates to methods, apparatuses, and systems that support collecting QoE measurements during mobility procedures, such as during intra-system, inter-RAT mobility procedures. For example, a core network can enhance messaging procedures between networks and UEs, expand the capabilities of a UE to perform QoE measurement collection in an LTE network (or during a related handover procedure), and/or extend (radio resource control) RRC messaging in LTE and NR networks for handling QoE reports after handovers are completed.

Some implementations of the method and apparatuses described herein may further include a UE having a processor and memory coupled with the processor, where the processor is configured to receive, from a network entity, a first message including a first configuration for handling QoE reports for network services that are buffered by the UE or not successfully transmitted by the UE prior to a RRC connected state mobility procedure; and transmit, after completing the RRC connected state mobility procedure, a second message to the network entity based on the first configuration, where the second message includes the QoE reports that were not successfully transmitted or were buffered by the UE prior to the RRC connected state mobility procedure.

In some implementations of the method and apparatuses described herein, the processor is further configured to receive, from the network entity, a request to provide radio access capabilities of the UE in an LTE network and transmit capability information identifying the radio access capabilities of the UE in the LTE to the network entity.

In some implementations of the method and apparatuses described herein, the radio access capabilities include a subset of the network services capable of being performed by the UE in the LTE network.

In some implementations of the method and apparatuses described herein, the processor is further configured to cause the UE to perform QoE measurement collections based on the first configuration and after completing the RRC connected state mobility procedure.

In some implementations of the method and apparatuses described herein, the UE receives the first message during a RRC connected state mobility procedure between network entities of different RATs.

In some implementations of the method and apparatuses described herein, the UE receives the first message from the network entity in an NR radio access network and transmits the second message to a network entity in an LTE radio access network.

In some implementations of the method and apparatuses described herein, the first message includes the configuration to discard the QoE reports for network services that are buffered by the UE or not successfully transmitted by the UE prior to the RRC connected state mobility procedure.

In some implementations of the method and apparatuses described herein, the network services include streaming services and MTSI services.

In some implementations of the method and apparatuses described herein, the UE is capable of QoE measurement collection in two or more different RATs.

In some implementations of the method and apparatuses described herein, the RRC connected state mobility procedure includes an intra-5GC inter-RAT handover procedure.

Some implementations of the method and apparatuses described herein may further include a method performed by a UE that includes receiving, from a network entity, a first message including a first configuration for handling QoE reports for network services that are buffered by the UE or not successfully transmitted by the UE prior to an RRC connected state mobility procedure and transmitting, after completing the RRC connected state mobility procedure, a second message to the network entity based on the first configuration that includes the QoE reports that were not successfully transmitted or were buffered by the UE prior to the RRC connected state mobility procedure.

In some implementations of the method and apparatuses described herein, the method further includes receiving, from the network entity, a request to provide radio access capabilities of the UE in an LTE network and transmitting capability information identifying the radio access capabilities of the UE in the LTE to the network entity.

In some implementations of the method and apparatuses described herein, the radio access capabilities include a subset of the network services capable of being performed by the UE in the LTE network.

In some implementations of the method and apparatuses described herein, the method further includes performing QoE measurement collections based on the first configuration and after completing the RRC connected state mobility procedure.

In some implementations of the method and apparatuses described herein, the first message is received during a RRC connected state mobility procedure between network entities of different RATs.

Some implementations of the method and apparatuses described herein may further include a network entity having a processor and a memory coupled with the processor, the processor configured to transmit, to a UE, a first message including a first configuration for handling QoE reports for network services not transmitted by the UE prior to a RRC connected state mobility procedure and receive, after completing the RRC connected state mobility procedure, from the UE, a second message based on the first configuration that includes the QoE reports not transmitted prior to the RRC connected state mobility procedure.

In some implementations of the method and apparatuses described herein, the QoE reports not transmitted by the UE prior to the RRC connected state mobility procedure include QoE reports stored in a buffer of the UE based on the first configuration.

In some implementations of the method and apparatuses described herein, the processor is further configured to transmit a request to obtain radio access capabilities of the UE in an LTE network and receive capability information identifying the radio access capabilities of the UE in the LTE.

In some implementations of the method and apparatuses described herein, the first message is transmitted during a RRC connected state mobility procedure between network entities of different RATs.

In some implementations of the method and apparatuses described herein, the first message includes the configuration to discard the QoE reports for network services that are buffered by the UE or not successfully transmitted by the UE prior to the RRC connected state mobility procedure.

In some implementations of the method and apparatuses described herein, the network services include streaming services and MTSI services.

Some implementations of the method and apparatuses described herein may further include a method performed by a network entity, the method including transmitting, to a UE a first message including a first configuration for handling QoE reports for network services not transmitted by the UE prior to an RRC connected state mobility procedure and receiving, after completing the RRC connected state mobility procedure, from the UE, a second message based on the first configuration that includes the QoE reports not transmitted prior to the RRC connected state mobility procedure.

In some implementations of the method and apparatuses described herein, the QoE reports not transmitted by the UE prior to the RRC connected state mobility procedure include QoE reports stored in a buffer of the UE based on the first configuration.

In some implementations of the method and apparatuses described herein, the method further includes transmitting a request to obtain radio access capabilities of the UE in an LTE network and receiving capability information identifying the radio access capabilities of the UE in the LTE.

In some implementations of the method and apparatuses described herein, the first message is transmitted during a RRC connected state mobility procedure between network entities of different RATs.

### BRIEF DESCRIPTION OF THE DRAWINGS

FIG. 1 illustrates an example of a wireless communications system that supports collecting QoE measurements during mobility procedures in accordance with aspects of the present disclosure.

FIG. 2 illustrates an example of a diagram that supports intra-system, inter-RAT, mobility procedures in accordance with aspects of the present disclosure.

FIG. 3 illustrates an example of a diagram that supports messaging between a network entity and a UE during intra-system, inter-RAT, mobility procedures in accordance with aspects of the present disclosure.

FIG. 4 illustrates an example of a diagram that supports a UE including a QoE measurement report buffer in accordance with aspects of the present disclosure.

FIG. 5 illustrates an example of a block diagram of a device that supports collecting QoE measurements during mobility procedures in accordance with aspects of the present disclosure.

FIG. 6 illustrates a flowchart of a method that supports collecting QoE measurements during mobility procedures in accordance with aspects of the present disclosure.

FIG. 7 illustrates a flowchart of a method that supports configuring a UE to collect QoE measurements during mobility procedures in accordance with aspects of the present disclosure.

### DETAILED DESCRIPTION

Different network access technologies provide different levels of support for QMC associated with various network services, such as streaming, MTSI, virtual reality (VR), and others. While operators of NR/5GC (5G Core) networks collect and utilize QoE measurement information for these network services, different access technologies provide different levels of support. For example, QMC in NR networks can be generic and flexible, whereas QMC in Long-Term Evolution (LTE), or 4G, networks is comparatively limited in flexibility and functionality.

The following table presents a comparison of how QMC is supported for the two different access technologies, LTE and NR:

| | LTE/EPC | NR/5GC |
|---|---|---|
| Types of QMC activation/deactivation | signaling-based and | signaling-based and |
| | management-based | management-based |
| Service types | Streaming, MTSI | Streaming, MTSI, VR |
| Max number of simultaneous measurement | 1 | 16 |
| configurations for encapsulated QoE | | |
| Max size of a measurement configuration | 1000 bytes | 8000 bytes |
| for encapsulated QoE | | |
| Max number of measurement reports for | 1 | 16 |
| encapsulated QoE which can be transmitted | | |
| in a single UL RRC message | | |
| Max size of a measurement report for | 8000 bytes | 144000 bytes |
| encapsulated QoE | | |
| UL RRC message segmentation | No | Yes |
| Pause/resume of measurement reporting | No | Yes |
| for encapsulated QoE | | |
| RAN-visible QoE | No | Yes |
| Per-slice QoE measurements for | No | Yes |
| encapsulated QoE | | |
| Session start/stop indication | No | Yes |
| Mobility | Only intra-system | Only intra-system |
| | intra-RAT | intra-RAT |

As the networks continue to develop, the QMC for these networks may support QoE measurements for additional network services, such as Augmented Reality (AR), Mixed Reality (MR), Multicast Broadcast Services (MBS), and others. In addition, the networks can support and benefit from maintaining continuity of QMC during mobility or handover procedures, such as during intra-5GC inter-RAT handover procedures or other procedures when a UE moves from a cell of one RAT to a cell of a different RAT.

Thus, due to the limitations associated with QMC in an LTE network, maintaining a continuity of QMC for various network services, as described herein, during intra-5GC inter-RAT handover (e.g., from NR to LTE) cannot be properly supported, as follows:
In NR, a UE may be configured with multiple QoE measurement configurations for streaming or MTSI services (e.g., with different slice configurations). However, after handover to an LTE network, only one of the configurations can be continued;
In NR, the size of an encapsulated QoE measurement configuration may be larger than 1000 bytes, but such a measurement configuration cannot be continued in LTE;
In NR, the measurement reporting of encapsulated QoE for one, multiple, or all QoE measurement configurations may be temporarily paused due to RAN overload. In the NR network, the UE's application layer continues with QMC, and any generated QoE reports are buffered in RRC. However, after handover to LTE occurs, QMC continues but the UE receives no guidance as to handling the associated buffered QoE reports upon completion of the handover (e.g., whether to discard or keep the reports);
In NR or LTE, when QoE reports have not yet been successfully transmitted and inter-RAT handover occurs, the UE has no guidance as to handling the pending reports;
In NR/5GC, the UE may generate an encapsulated QoE measurement report having a size larger than 8000 bytes but cannot send a QoE report of that size to a network entity in an LTE network; and so on.

Thus, there are various issues with respect to QoE measurement collection and reporting during handover procedures, such as those procedures where a UE moves from an NR network to an LTE network. The technology described herein seeks to alleviate such issues by providing new messaging procedures between networks and UEs, by expanding the capabilities of a UE to perform QoE measurement collection in an LTE network (or during a related handover procedure), and/or extending RRC messaging in LTE and NR networks for handling QoE reports after handovers are completed.

These various enhancements to QMC procedures can enable and support maintaining a continuity of QMC for streaming services and MTSI services (and other network services) during intra-5GC inter-RAT handover procedures, among other benefits.

Aspects of the present disclosure are described in the context of a wireless communications system. Aspects of the present disclosure are further illustrated and described with reference to device diagrams and flowcharts.

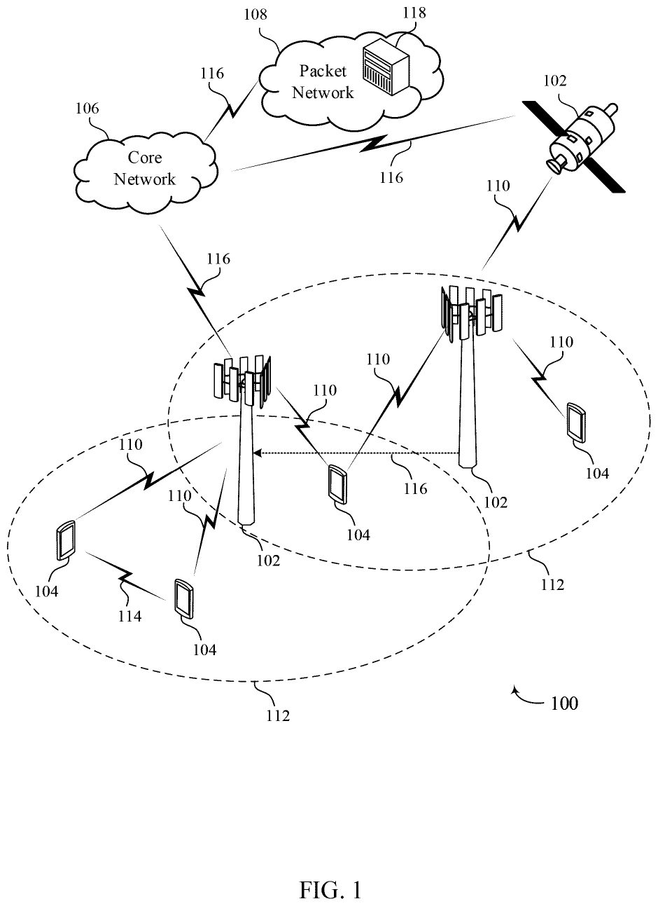

FIG. 1 illustrates an example of a wireless communications system 100 that supports collecting QoE measurements during mobility procedures in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHZ-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

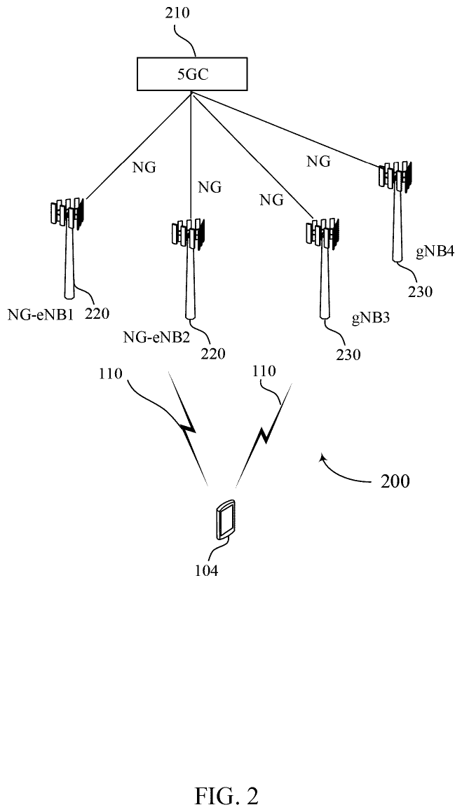

As described herein, the UE 104 can be part of a 5GC network, which includes various types of network entities or nodes. FIG. 2 illustrates an example of a diagram 200 that supports intra-system, inter-RAT, mobility procedures in accordance with aspects of the present disclosure.

As shown, a 5GC network 210 provides RAN coverage to the UE 104 via one or more ng-eNBs 220 and gNBs 230. The ng-eNBs 220 and gNBs 230 are RAN nodes (e.g., NG-RAN) that provide LTE access and NR access, respectively, to the UE 104 and connect via an NG interface to the 5GC network 210. The ng-eNBs 220 and gNBs 230 may be interconnected with each other via an Xn interface or another backhaul link.

Thus, the different RAN nodes can provide the UE 104 with various network services, such as streaming and MTSI services. The UE 104 performs QMC while connected to the different nodes, as well as during handover procedures within the 5GC network 210 (e.g., intra-5GC), such as handovers from the gNBs 230 to the ng-eNBs 220 (e.g., inter-RAT). As described herein, certain enhancements within messaging between the 5C network 210 and the UE 104 can facilitate a continuous QoE measurement collection and reporting for the UE 104 during these handover/mobility procedures, among other enhancements.

In some embodiments, the 5GC network 210 can update or provide new messaging to configure the collection/reporting performed by the UE 104. The 5GC network 210 can introduce a new 5GC version of IE OtherConfig in a RRCConnectionReconfiguration message for configuring QoE measurements. For example, the following signaling structure depicts the configuration of QoE measurements, via the parameter measConfigAppLayer-5GC-r18:

| | | |
|---|---|---|
| measConfigAppLayer-5GC-r18 | MeasConfigAppLayer-5GC-r18 | OPTIONAL -- Need ON |

MeasConfigAppLayer-5GC-r18 ::= SEQUENCE {
measConfigAppLayerToSetupList-r18 SEQUENCE (SIZE (1..maxNrofAppLayerMeas-r18)) OF

| | |
|---|---|
| MeasConfigAppLayerToSetup-r18 | OPTIONAL, -- Need |

ON
measConfigAppLayerToReleaseList-r18 SEQUENCE (SIZE (1..maxNrofAppLayerMeas-r18)) OF

| | |
|---|---|
| MeasConfigAppLayerId-r18 | OPTIONAL, -- |

Need ON

| | | |
|---|---|---|
| rrc-SegAllowed-r18 | ENUMERATED {enabled} | OPTIONAL -- Need |

OR
}
MeasConfigAppLayerToSetup-r18 ::= SEQUENCE {

| | |
|---|---|
| measConfigAppLayerId-r18 | MeasConfigAppLayerId-r18, |

measConfigAppLayerContainer-r18 OCTET STRING (SIZE (1..8000),

| | |
|---|---|
| serviceType-r18 | ENUMERATED {streaming, mtsi} |

}
MeasConfigAppLayerId-r18 ::= INTEGER (0..maxNrofAppLayerMeas-1-r18)

Within the signaling structure (1) the parameter measConfigAppLayerToSetupList-r18 indicates the list of QoE measurements to setup. The maximum size of the list is given by the constant maxNrofAppLayerMeas-r18 and can be set to a value of e.g., 2, 4, 8 or 16; (2) the parameter measConfigAppLayerToReleaseList-r18 indicates the list of QoE measurements to release; (3) the parameter rrc-SegAllowed-r18 indicates whether RRC segmentation of MeasReportAppLayer-5GC-r18 message is allowed or not, (4) the parameter measConfigAppLayerId-r18 identifies the QoE measurement to setup, (5) the parameter measConfigAppLayerContainer-r18 contains the configuration of QoE measurement. The size of the container can be up to 8000 bytes; and (6) the parameter serviceType-r18 indicates the type of QoE measurement. Value “streaming” indicates streaming service and value “mtsi” indicates MTSI service.

Further, the 5GC network 210 can introduce a 5GC message MeasReportAppLayer-5GC-r18 for reporting QoE measurements. For example, the message can have the following signaling structure:

MeasReportAppLayer-5GC-r18 ::= SEQUENCE {

| measReportAppLayerList-r18 | MeasReportAppLayerList-r18, | |
|---|---|---|
| lateNonCriticalExtension | OCTET STRING | OPTIONAL, |
| nonCriticalExtension | SEQUENCE{ } | OPTIONAL |

}
MeasReportAppLayerList-r18 ::= SEQUENCE (SIZE (1..maxNrofAppLayerMeas-r18)) OF
MeasReportAppLayer-r18
MeasReportAppLayer-r18 ::= SEQUENCE {

| | |
|---|---|
| measConfigAppLayerId-r18 | MeasConfigAppLayerId-r18, |
| measReportAppLayerContainer-r18 | OCTET STRING |

}

Within the signaling structure, (1) the parameter measReportAppLayerList-r18 indicates the list of QoE measurements to report. The maximum number of reports is given by the constant maxNrofAppLayerMeas-r18 and can be set to a value of e.g., 2, 4, 8 or 16; (2) the parameter measConfigAppLayerId-r18 identifies the QoE measurement report; and (3) the parameter measReportAppLayerContainer-r18 contains the QoE measurement report. The size of the container can be up to 144000 bytes.

In some embodiments, the 5GC network 210 can update or provide new capabilities for 5GC QoE measurement collection in LTE networks and during inter-RAT handover procedures. For example, an LTE UECapabilityInformation message can include the following capabilities:
The capability qoe-Streaming-MeasReport-5GC-r18, which indicates whether the UE supports QoE measurement collection for streaming services in LTE/5GC;
The capability qoe-MTSI-MeasReport-5GC-r18, which indicates whether the UE supports QoE measurement collection for MTSI services in LTE/5GC;
The capability qoe-MeasReportAppLayer-Segmentation-5GC-r18, which indicates whether the UE supports segmentation of the MeasReportAppLayer-5GC-r18 message in LTE/5GC;
The capability qoe-LTE-5GC-HO-ToNR-r18, which indicates whether the UE supports handover from LTE/5GC to NR/5GC for QoE measurement collection; and so on.

Further, an NR UECapabilityInformation message can include a capability, qoe-NR-HO-TOLTE-5GC-r18, which indicates whether the UE supports handover from NR/5GC to LTE/5GC for QoE measurement collection.

Further, in some embodiments, the 5GC network 210 can extend RRC reconfiguration messages in LTE and/or NR for handling QoE reports after completion of handover procedures. The 5GC network 210 can introduce an extension to RRC reconfiguration messages in LTE (RRCConnectionReconfiguration) and NR (RRCReconfiguration) for handling of QoE reports after handover procedures.

For example, an RRC reconfiguration message can have the following signaling structure:

| | |
|---|---|
| qoe-MeasReportHO-List-r18 | SEQUENCE (SIZE (1..maxNrofAppLayerMeas-r18)) OF |

QoE-MeasReportHO-r18
QoE-MeasReportHO-r18 ::= SEQUENCE {

| | |
|---|---|
| measConfigAppLayerId-r18 | MeasConfigAppLayerId-r18, |
| measReportConfig-r18 | ENUMERATED {discard, continue} |

}

Within the signaling structure, (1) the parameter qoe-MeasReportHO-List-r18 indicates the list of QoE measurement configurations which are continued after successful handover; (2) the parameter measConfigAppLayerId-r18 identifies the QoE measurement configuration; (3) the parameter measReportConfig-r18 indicates how the UE shall handle buffered QoE reports or QoE reports, which have not been successfully transmitted prior the handover. Value “discard” indicates that the concerned QoE reports shall be discarded. Value “continue” indicates that the concerned QoE reports shall be kept and transmitted upon completion of handover.

Thus, as described herein, the 5GC network 210 can enhance and extend the messaging between network nodes and the UE 104 to remove or reduce limitations within an LTE network with regards to configuration and reporting of QoE measurements for streaming and MTSI services, to support continuity of QMC for streaming and MTSI services during intra-5GC inter-RAT handover, and control the handling of QoE reports, which are buffered or which have not been successfully transmitted prior the intra-5GC handover, among other enhancements.

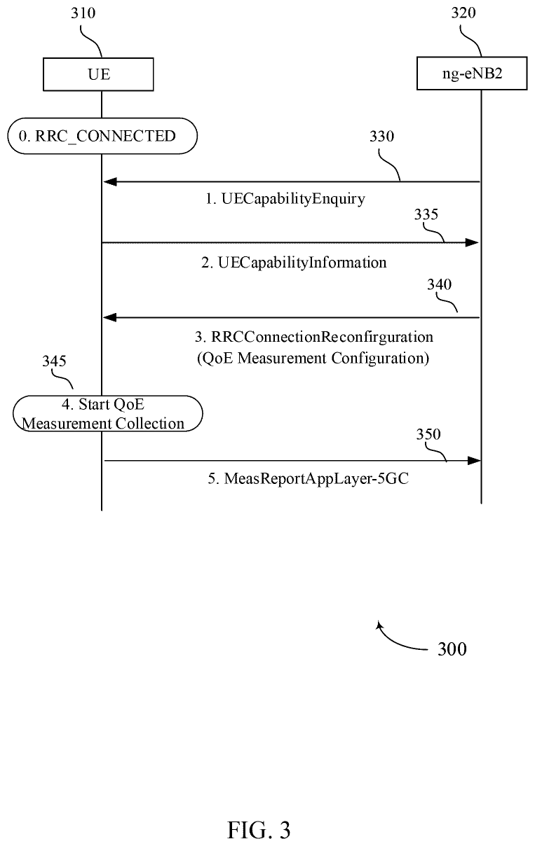

FIG. 3 illustrates an example of a diagram 300 that supports messaging between a network entity and a UE during intra-system, inter-RAT, mobility procedures in accordance with aspects of the present disclosure. As described herein, the 5GC network 210 can provide RAN coverage to a QMC-capable UE (e.g., the UE 104) via different RAT nodes, such as the ng-eNBs 220 and the gNBs 230.

An OAM (operations, administration, and maintenance) entity associated with the 5GC network 210 operates to obtain QoE measurements for streaming and MTSI services from UEs, such as a UE 310, being served by an ng-eNB2 320. The OAM sends to the network a “Configure QoE measurement” message, which can include measurement configurations for the network services. Then, the 5GC network 210 sends to the ng-eNB2 320 an “Activate QoE measurement” message, which includes the requested QoE measurement configurations.

The UE 310 is in a connected state (e.g., an RRC connected state), and receives data for streaming services and MTSI services. The ng-eNB2 320 sends to the UE 310 a request message 330 (e.g., a UECapabilityEnquiry message) to request information for UE radio access capabilities of the UE 310 for LTE, to determine whether the UE 310 is qualified to collect QoE measurements for the streaming and MTSI services.

The UE 310 sends a response message 335 (e.g., a UECapabilityInformation message), which includes capability information, such as: the capability qoe-Streaming-MeasReport-5GC-r18 set to “supported”, the capability qoe-MTSI-MeasReport-5GC-r18 set to “supported”, the capability qoe-MeasReportAppLayer-Segmentation-5GC-r18 set to “supported”, and the capability qoe-LTE-5GC-HO-ToNR-r18 set to “supported”.

Based on the capability information received from the UE 310, the ng-eNB2 320 determines that the UE is qualified for QoE measurement collection for the network services and sends a configuration 340 (e.g., a RRCConnectionReconfiguration message) that includes respective QoE measurement configurations in the new measConfigAppLayer-5GC-r18.

Based on the received configuration 340, the UE 310 starts or initiates QoE measurement collection 345 (e.g., transferring the received configuration 340 from its access stratum (AS) layer to its Application Layer (AL)).

Finally, based on a configured reporting interval defined in the configuration 340, the UE 310, via its AL, sends first collected measurement results for the streaming services to its AS layer in a QoE measurement report. The UE AS layer sends the QoE measurement report via a reporting message 350 (e.g., an LTE MeasReportAppLayer-5GC-r18 message) to the ng-eNB2 320, and the ng-eNB2 320 forwards the received QoE measurement report to an MCE (Measurement Collection Entity).

As described herein, in some embodiments, the 5GC network 210 facilitates the continuity of QMC during handover procedures. For example, an OAM requests QoE measurements for streaming and MTSI services from UEs being served by the ng-eNBs 220 (e.g., ng-eNB1 and ng-eNB2) and the gNBs 230 (e.g., gNB3 and gNB4) and sends the network a “Configure QoE measurement” message that includes QoE measurement configurations for the network services.

The 5GC network 210 sends to the network nodes 220, 230, (ng-eNB1, ng-eNB2, gNB3 and gNB4) an “Activate QoE measurement” message that includes the QoE measurement configurations. The 5GC network 210 includes a QMC-capable UE, which is in a connected state and is receiving data for streaming and MTSI services in a cell served by the node ng-eNB2. Further, the UE supports handover from LTE/5GC to NR/5GC for QoE measurement collection (e.g., in the UECapabilityInformation message the capability qoe-LTE-5GC-HO-ToNR-r18 has been set to “supported”), and, based on the messaging depicted in FIG. 3, the UE has been configured by the ng-eNB2 for QMC of streaming and MTSI services, and the UE collects QoE measurements and sends them via the LTE MeasReportAppLayer-5GC-r18 message to the ng-eNB2.

Due to mobility, the UE is in the coverage of the cell that is served by the gNB3 as well. Based on radio measurements received from the UE, the ng-eNB2 determines that the gNB3 provides better coverage to the UE and initiates handover to the gNB3. As part of the intra-5GC inter-RAT handover procedure, the ng-eNB2 passes information to prepare the handover at the target gNB3 (e.g., the AS configuration and QoE configuration of the UE at the source ng-eNB2).

The target gNB3 performs admission control (e.g., checks whether the radio resources for the UE can be granted and QMC can be continued). When successful, the target gNB3 sends to the source ng-eNB2 the information to perform the handover procedure. The source ng-eNB2 sends a MobilityFromEUTRACommand message to the UE to command the UE to perform the handover to the target gNB3. After successful completion of the handover procedure, the UE continues with reception of data for streaming and MTSI services and QMC in the new cell.

As described herein, in some embodiments, the 5GC network 210 facilitates the continuity of QMC during handover procedures for different network services. For example, an OAM requests QoE measurements for streaming and MTSI services from UEs being served by the ng-eNBs 220 (e.g., ng-eNB1 and ng-eNB2) and the gNBs 230 (e.g., gNB3 and gNB4) and for VR services for UEs being serviced by the gNBs 230. The OAM sends the network 210 a “Configure QoE measurement” message that includes QoE measurement configurations for the network services.

The 5GC network 210 sends to the network nodes 220, 230, (ng-eNB1, ng-eNB2, gNB3 and gNB4) an “Activate QoE measurement” message that includes the QoE measurement configurations. The 5GC network 210 includes a QMC-capable UE, which is in a connected state and is receiving data for streaming, MTSI, and VR services in a cell served by the node gNB3. Further, the UE supports handover from NR/5GC to LTE/5GC for QoE measurement collection (e.g., in the UECapabilityInformation message the capability qoe-NR-HO-TOLTE-5GC-r18 has been set to “supported”), and, based on the messaging depicted in FIG. 3, the UE has been configured by the gNB3 for QMC of streaming, MTSI, and VR services, and the UE collects QoE measurements and sends them via the NR MeasurementReportAppLayer message to the gNB3.

Due to mobility, UE is in the coverage of the cell that is served by the ng-eNB2 as well. Based on radio measurements received from the UE, the gNB3 determines that the ng-eNB2 provides better coverage to the UE and initiates handover to the ng-eNB2. As part of the intra-5GC inter-RAT handover procedure, the gNB3 sends information to prepare the handover at the target ng-eNB2 (e.g., the AS configuration and QoE configuration of the UE at the source gNB3).

The target ng-eNB2 performs admission control (e.g., checks whether the radio resources for the UE can be granted and QMC can be continued), and determines that the admission control was partly successful. The target ng-eNB2 determines that it supports only the streaming and MTSI services and QMC for both services, and the VR service and QMC for VR is to be dropped. Therefore, the target ng-eNB2 sends to the source gNB3 such information for the handover procedure. The source gNB3 sends then the MobilityFromNRCommand message to the UE to command the UE to perform the handover to the target ng-eNB2, to continue QMC for streaming and MTSI services, and to stop QMC for the VR service. After successful completion of the handover procedure, the UE continues with reception of data for streaming and MTSI services and QMC for both services in the new cell.

As described herein, in some embodiments, the network can control how the UE buffers QoE reports during handover procedures. Given a scenario similar to the UE that moved from the gNB3 to the ng-eNB2, the network also experiences a RAN overload in the gNB3, and QoE measurement reporting has been paused for the configured QoE measurements. For example, UE application layer still continues with QMC but the generated QoE reports are buffered in RRC.

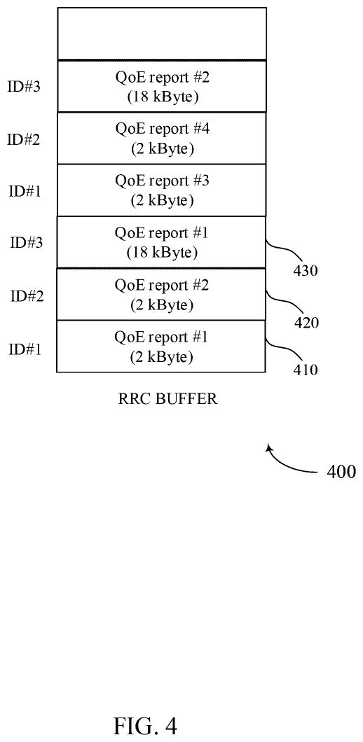

FIG. 4 illustrates an example of a diagram 400 that supports a UE including a QoE measurement report buffer in accordance with aspects of the present disclosure. As depicted, 6 QoE reports of total 44 kBytes are buffered for transmission (2 QoE reports with QoE configuration identity #1 for streaming 410, 2 QoE reports with QoE configuration identity #2 for MTSI 420, and 2 QoE reports with QoE configuration identity #3 for VR 430).

The gNB3 initiates handover to ng-eNB2 due to UE mobility. However, the target ng-eNB2 only supports the continuation of the streaming and MTSI services and QMC for both services. The target ng-eNB2 sends to the source gNB3 such information for the handover procedure. In addition, the target ng-eNB2 sends to the source gNB3 the information that any buffered QoE reports for the continued services shall be kept and sent to the ng-eNB2 after successful completion of the handover. The source gNB3 sends the MobilityFromNRCommand message to the UE to command the UE to perform the handover to the target ng-eNB2, to continue QMC for streaming and MTSI services, to stop QMC for VR service, and to keep the buffered QoE reports for streaming and MTSI services and to send them after successful completion of handover.

After successful completion of the handover, the UE continues with reception of data for streaming and MTSI services and QMC for both services in the new cell. Furthermore, the UE discards the buffered QoE reports for VR service, and initiates QoE measurement reporting procedure in the new cell to send the buffered QoE reports for streaming and MTSI services.

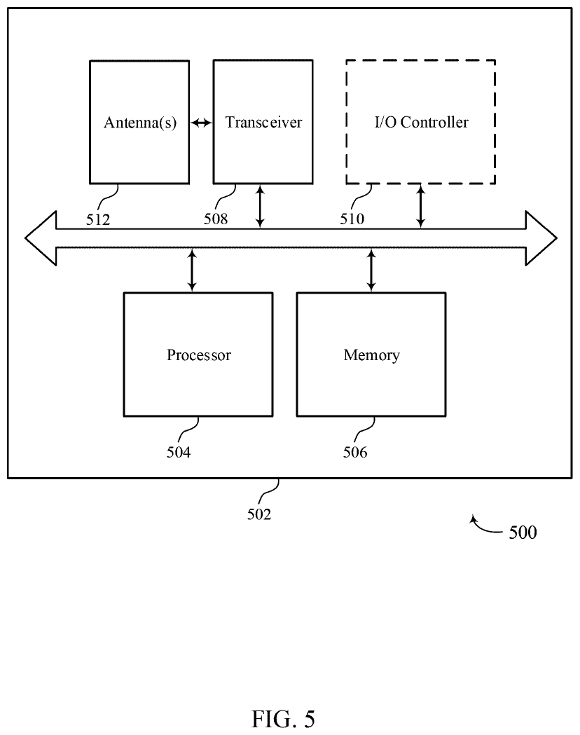

FIG. 5 illustrates an example of a block diagram 500 of a device 502 that supports collecting quality of experience (QoE) measurements during mobility procedures in accordance with aspects of the present disclosure. The device 502 may be an example of a network entity 102 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for transmitting to a UE a first message including a first configuration for handling Quality of Experience (QoE) reports for network services not transmitted by the UE prior to a RRC connected state mobility procedure and receiving, after completing the RRC connected state mobility procedure, from the UE, a second message based on the first configuration that includes the QoE reports not transmitted prior to the RRC connected state mobility procedure.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor M06. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

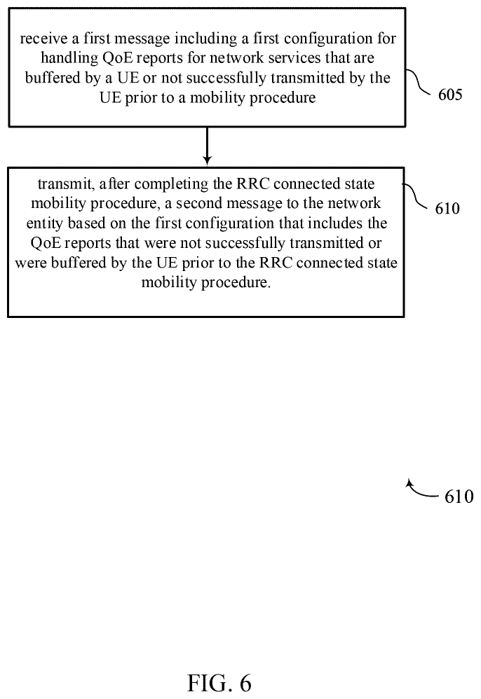

FIG. 6 illustrates a flowchart of a method 600 that supports collecting QoE measurements during mobility procedures in accordance with aspects of the present disclosure. The operations of the method 600 may be implemented by a device or its components as described herein. For example, the operations of the method 600 may be performed by the UE 104 or the UE 310 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 605, the method may include receiving, from a network entity, a first message including a first configuration for handling QoE reports for network services that are buffered by the UE or not successfully transmitted by the UE prior to an RRC connected state mobility procedure. The operations of 605 may be performed in accordance with examples as described herein. In some implementations, aspects of the operations of 605 may be performed by a device as described with reference to FIG. 1.

At 610, the method may include transmitting, after completing the RRC connected state mobility procedure, a second message to the network entity based on the first configuration that includes the QoE reports that were not successfully transmitted or were buffered by the UE prior to the RRC connected state mobility procedure. The operations of 610 may be performed in accordance with examples as described herein. In some implementations, aspects of the operations of 610 may be performed by a device as described with reference to FIG. 1.

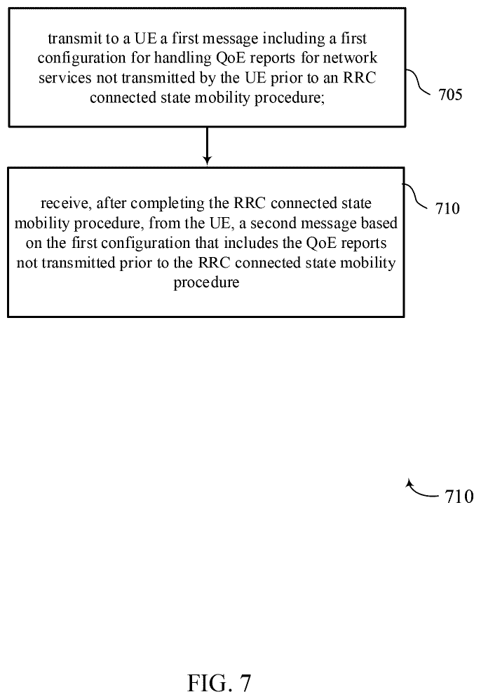

FIG. 7 illustrates a flowchart of a method 700 that supports configuring a UE to collect QoE measurements during mobility procedures in accordance with aspects of the present disclosure. The operations of the method 700 may be implemented by a device or its components as described herein. For example, the operations of the method 700 may be performed by the network entity 102 or other network node (e.g., ng-eNB2 320) as described with reference to FIGS. 1 through 5. In some implementations, the device may execute a set of instructions to control the function elements of the device to perform the described functions. Additionally, or alternatively, the device may perform aspects of the described functions using special-purpose hardware.

At 705, the method may include transmitting, to a UE, a first message including a first configuration for handling QoE reports for network services not transmitted by the UE prior to an RRC connected state mobility procedure. The operations of 705 may be performed in accordance with examples as described herein. In some implementations, aspects of the operations of 705 may be performed by a device as described with reference to FIG. 1.

At 710, the method may include receiving, after completing the RRC connected state mobility procedure, from the UE, a second message based on the first configuration that includes the QoE reports not transmitted prior to the RRC connected state mobility procedure. The operations of 710 may be performed in accordance with examples as described herein. In some implementations, aspects of the operations of 710 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
a at least one memory; and
at least one processor coupled with the at least one memory and configured to cause the UE to:
receive a first message including a first configuration for handling Quality of Experience (QoE) reports for network services that are buffered by the UE or not successfully transmitted by the UE prior to a radio resource control (RRC) connected state mobility procedure; and
transmit, after completing the RRC connected state mobility procedure, a second message based on the first configuration, wherein the second message includes the QoE reports that were not successfully transmitted or were buffered by the UE prior to the RRC connected state mobility procedure.

2. The UE of claim 1, wherein the at least one processor is further configured to cause the UE to:
receive a request to provide radio access capabilities of the UE in a Long-Term Evolution (LTE) network; and
transmit capability information identifying the radio access capabilities of the UE in the LTE.

3. The UE of claim 2, wherein the radio access capabilities include a subset of the network services capable of being performed by the UE in the LTE network.

4. The UE of claim 1, wherein the at least one processor is further configured to cause the UE to perform QoE measurement collections based on the first configuration and after completing the RRC connected state mobility procedure.

5. The UE of claim 1, wherein the first message is received during an RRC connected state mobility procedure.

6. The UE of claim 1, wherein:
the first message is received over a new radio (NR) radio access network, and wherein
the second message is transmitted over a Long-Term Evolution (LTE) radio access network.

7. The UE of claim 1, wherein the first message includes the configuration to discard the QoE reports for network services that are buffered by the UE or not successfully transmitted by the UE prior to the RRC connected state mobility procedure.

8. The UE of claim 1, wherein the network services include streaming services and multimedia telephony services for IMS (MTSI) services.

9. The UE of claim 1, wherein the UE is capable of QoE measurement collection in two or more different radio access technologies (RATs).

10. The UE of claim 1, wherein the RRC connected state mobility procedure includes an intra-5GC inter-RAT (radio access technology) handover procedure.

11. A method performed by a user equipment (UE), the method comprising:
receiving a first message including a first configuration for handling Quality of Experience (QoE) reports for network services that are buffered by the UE or not successfully transmitted by the UE prior to a radio resource control (RRC) connected state mobility procedure; and
transmitting, after completing the RRC connected state mobility procedure, a second message based on the first configuration that includes the QoE reports that were not successfully transmitted or were buffered by the UE prior to the RRC connected state mobility procedure.

12. The method of claim 11, further comprising:
receiving a request to provide radio access capabilities of the UE in a Long-Term Evolution (LTE) network; and
transmitting capability information identifying the radio access capabilities of the UE in the LTE.

13. The method of claim 12, wherein the radio access capabilities include a subset of the network services capable of being performed by the UE in the LTE network.

14. The method of claim 12, further comprising:
performing QoE measurement collections based on the first configuration and after completing the RRC connected state mobility procedure.

15. The method of claim 12, wherein the first message is received during a RRC connected state mobility procedure.

16. A network entity, comprising:
at least one memory; and
at least one processor coupled with the at least one memory and configured to cause the network entity to:
transmit, to a user equipment (UE), a first message including a first configuration for handling Quality of Experience (QoE) reports for network services not transmitted by the UE prior to a radio resource control (RRC) connected state mobility procedure; and
receive, after completing the RRC connected state mobility procedure, from the UE, a second message based on the first configuration that includes the QoE reports not transmitted prior to the RRC connected state mobility procedure.

17. The network entity of claim 16, wherein the QoE reports not transmitted by the UE prior to the RRC connected state mobility procedure include QoE reports stored in a buffer of the UE based on the first configuration.

18. The network entity of claim 16, wherein the at least one processor is further configured to cause the network entity to:
transmit a request to obtain radio access capabilities of the UE in a Long-Term Evolution (LTE) network; and
receive capability information identifying the radio access capabilities of the UE in the LTE.

19. The network entity of claim 16, wherein the first message is transmitted during a RRC connected state mobility procedure.

20. (canceled)

21. A method performed by a network entity, the method comprising:
transmitting, to a user equipment (UE), a first message including a first configuration for handling Quality of Experience (QoE) reports for network services not transmitted by the UE prior to a radio resource control (RRC) connected state mobility procedure; and
receiving, after completing the RRC connected state mobility procedure, from the UE, a second message based on the first configuration that includes the QoE reports not transmitted prior to the RRC connected state mobility procedure.
